(19) United States
(12) Patent Application Publication
(10) Pub. No.: US 2026/0142449 A1
(43) Pub. Date: May 21, 2026

(54) MOTOR CONTROL METHOD AND APPARATUS, DEVICE, AND STORAGE MEDIUM

(71) Applicant: THE HONG KONG UNIVERSITY OF SCIENCE AND TECHNOLOGY (GUANGZHOU), Guangzhou (CN)

(72) Inventors: Hang ZHAO, Guangzhou (CN); Zhenxiao YIN, Guangzhou (CN); Xueyan WANG, Guangzhou (CN); Zhijun OU, Guangzhou (CN); Ming LIU, Guangzhou (CN)

(21) Appl. No.: 19/092,366

(22) Filed: Mar. 27, 2025

(30) Foreign Application Priority Data
Nov. 21, 2024 (CN) 202411676788.8

(51) Int. Cl. H02H 7/093; H02H 7/08

(52) U.S. Cl. CPC H02H 7/093; H02H 7/0833

(57) ABSTRACT

A motor control method includes: acquiring a first rotational speed error of a rotor of a motor corresponding to a current moment; acquiring a speed compensation value for the rotor according to a preset speed drop graph, which represents a graphical representation of speed versus time when a rotational speed of the rotor drops; calculating an electric current compensation value according to the speed compensation value and a preset speed-current mapping model; acquiring an electric current reference value corresponding to the current moment, which is an electric current value for controlling the rotational speed of the rotor; and controlling the motor according to the electric current compensation value if the first rotational speed error is greater than a preset error, or controlling the motor according to the electric current reference value if the first rotational speed error is less than or equal to the preset error.

### CROSS-REFERENCE TO RELATED APPLICATION

This application is based on and claims the benefit of priority from Chinese Patent Application No. 2024116767888, filed on 21 Nov. 2024, the entirety of which is incorporated by reference herein.

### TECHNICAL FIELD

The present disclosure relates to the technical field of motor control, and in particular, to a motor control method and apparatus, a device, and a storage medium.

### BACKGROUND

Motors are widely used in scenarios such as electric vehicles, more electric aircrafts, unmanned flying vehicles, drones, and unmanned ships. Usually, a motor may experience a certain degree of speed drop during operation due to a sudden change of the external environment or a sudden external disturbance, and such a drop sometimes leads to the instability and stall of the motor. Therefore, when a speed drop occurs, it is necessary to quickly compensate for the speed drop of the motor. In the related art, compensation for the speed drop of the motor using a load torque observer is an indirect compensation scheme based on a physical model. The physical model is usually a simplified model, and some parameters in the simplified model are uncertain, resulting in insufficient accuracy of the simplified model and unsatisfactory compensation effect. Therefore, how to improve the compensation accuracy when a motor is experiencing a speed drop has become an urgent technical problem to be addressed.

### SUMMARY

A main objective of embodiments of the present disclosure is to provide a motor control method and apparatus, a device, and a storage medium, to improve the compensation accuracy when a motor is experiencing a speed drop.

To achieve the above objective, in accordance with a first aspect of the present disclosure, an embodiment provides a motor control method, including:
acquiring a rotational speed error of a rotor of a motor corresponding to a current moment as a first rotational speed error;
acquiring a speed compensation value for the rotor according to a speed drop graph which is preset, where the speed drop graph represents a graphical representation of speed versus time when a rotational speed of the rotor drops;
calculating an electric current compensation value according to the speed compensation value and a speed-current mapping model which is preset;
acquiring an electric current reference value corresponding to the current moment, where the electric current reference value is an electric current value for controlling the rotational speed of the rotor;
controlling the motor according to the electric current compensation value in response to the first rotational speed error being greater than a preset error; and
controlling the motor according to the electric current reference value in response to the first rotational speed error being less than or equal to the preset error.

In some embodiments, the speed drop graph includes a speed drop region, and acquiring a speed compensation value for the rotor according to a speed drop graph which is preset includes:
determining a drop length variable and a drop width variable according to the speed drop region;
acquiring a rotational speed error of the rotor corresponding to a next moment as a second rotational speed error, where the next moment is a moment next to the current moment; and
calculating the speed compensation value according to the first rotational speed error, the second rotational speed error, the drop length variable, and the drop width variable.

In some embodiments, calculating the speed compensation value according to the first rotational speed error, the second rotational speed error, the drop length variable, and the drop width variable includes:
inputting the first rotational speed error, the second rotational speed error, the drop length variable, and the drop width variable into a speed compensation value calculation model which is preset to obtain the speed compensation value,
where the speed compensation value calculation model is:

$$\tilde{ω} = {σ}_{f}^{2} exp ( - {‖ {e}_{{ω}_{k + 1}} - {e}_{{ω}_{k}} ‖}_{2}^{2} / {\tilde{l}}^{2} ) ;$$

$${\tilde{l}}^{2} = {‖ {( \frac{d {e}_{ω}}{dt} )}^{- 1} ‖}_{2}^{- 2} 2 {l}^{2} ;$$

where \tilde{ω} represents the speed compensation value, σ_{f} represents the drop length variable, σ_{f}ϵ [symbol] , l represents the drop width variable, lϵ [symbol] , e_{ω}_{ₖ} represents the first rotational speed error, e_{w}_{ₖ₊₁} represents the second rotational speed error, \tilde{l} represents an intermediate parameter, and e_{ω} represents a rotational speed error of the rotor.

In some embodiments, before inputting the first rotational speed error, the second rotational speed error, the drop length variable, and the drop width variable into a speed compensation value calculation model which is preset to obtain the speed compensation value, the method further includes:
building the speed compensation value calculation model, including:
   acquiring speed drop data according to the speed drop graph, and building an equivalent model of the speed drop graph according to the speed drop data;
   transforming the equivalent model into an equivalent inverse model; and
   building the speed compensation value calculation model according to the equivalent inverse model and a preset rotational speed error model.

In some embodiments, before calculating an electric current compensation value according to the speed compensation value and a speed-current mapping model which is preset, the method further includes:
building the speed-current mapping model, including:
   acquiring a motor parameter and a second actual rotational speed of the rotor corresponding to a next moment; and
   building the speed-current mapping model according to the speed compensation value, the motor parameter, the electric current reference value, the second actual rotational speed, and a speed-current function which is preset, where the speed-current function represents a positive correlation between a q-axis current and the rotational speed of the rotor.

In some embodiments, the motor parameter includes a number of pole pairs, a flux linkage, an inertia, a q-axis current corresponding to the current moment, a d-axis current corresponding to a previous moment, a d-axis inductance, and a q-axis inductance, and building the speed-current mapping model according to the speed compensation value, the motor parameter, the electric current reference value, the second actual rotational speed, and a speed-current function which is preset includes:
building the speed-current mapping model according to the speed compensation value, the number of pole pairs, the flux linkage, the inertia, the q-axis current corresponding to the current moment, the d-axis current corresponding to the previous moment, the d-axis inductance, and the q-axis inductance, the electric current reference value, the second actual rotational speed, and a preset speed-current relationship,
where the speed-current mapping model is:

$$\frac{\partial {I}_{{q}_{k}}}{\partial {ω}_{k + 1}} = {( \frac{\partial {ω}_{k + 1}}{\partial \vert {I}_{{q}_{k}} \vert} )}^{- 1} = {( ( \frac{3 {p}_{n} {ψ}_{f}}{2 {J}_{m}} + \frac{3 {p}_{n} ( {L}_{d} - {L}_{q} ) {I}_{d , k - 1}}{2 {J}_{m}} ) {T}_{s} )}^{- 1} ;$$

$${\tilde{I}}_{{q}_{ref , k}} = \frac{\partial {I}_{{q}_{k}}}{\partial {ω}_{k + 1}} \tilde{ω} + {I}_{{q}_{ref , k}} ;$$

where I_{qk} represents the q-axis current corresponding to the current moment, ωₖ₊₁ represents the second actual rotational speed, pₙ represents the number of pole pairs, ψ_{f} represents the flux linkage, ψ_{f}ϵ [symbol] , Jₘ represents the inertia, Jₘϵ [symbol] , L_{d} represents the d-axis inductance, L_{q} represents the q-axis inductance, L_{d}, L_{q}ϵ [symbol] I_{d,k-1} represents the d-axis current corresponding to the previous moment, Tₛ represents a time difference between the next moment and the current moment, Ĩ_{q}_{_{ref,k}} represents the electric current compensation value, \tilde{ω} represents the speed compensation value, and I_{q}_{_{ref,k}} represents the electric current reference value.

In some embodiments, acquiring a rotational speed error of a rotor of a motor corresponding to a current moment as a first rotational speed error includes:
acquiring a position of the rotor corresponding to the current moment as a first rotor position;
acquiring a position of the rotor corresponding to a next moment as a second rotor position, where a difference between the next moment and the current moment is a target time difference;
calculating a first actual rotational speed of the rotor corresponding to the current moment according to the first rotor position, the second rotor position, and the target time difference;
acquiring a first reference rotational speed corresponding to the current moment, where the first reference rotational speed is a corresponding rotational speed of the motor when the electric current reference value is applied to the motor; and
calculating the first rotational speed error according to the first reference rotational speed and the first actual rotational speed.

To achieve the above objective, in accordance with a second aspect of the present disclosure, an embodiment provides a motor control apparatus, including:
a first acquisition module, configured for acquiring a rotational speed error of a rotor of a motor corresponding to a current moment as a first rotational speed error;
a second acquisition module, configured for acquiring a speed compensation value for the rotor according to a speed drop graph which is preset, where the speed drop graph represents a graphical representation of speed versus time when a rotational speed of the rotor drops;
a calculation module, configured for calculating an electric current compensation value according to the speed compensation value and a speed-current mapping model which is preset;
a third acquisition module, configured for acquiring an electric current reference value corresponding to the current moment, where the electric current reference value is an electric current value for controlling the rotational speed of the rotor;
a first control module, configured for controlling the motor according to the electric current compensation value if the first rotational speed error is greater than a preset error; and
a second control module, configured for controlling the motor according to the electric current reference value if the first rotational speed error is less than or equal to the preset error.

To achieve the above objective, in accordance with a third aspect of the present disclosure, an embodiment provides an electronic device, including a memory and a processor, where the memory is configured for storing a computer program which, when executed by the processor, causes the processor to implement the method in accordance with the first aspect.

To achieve the above objective, in accordance with a fourth aspect of the present disclosure, an embodiment provides a computer-readable storage medium, storing a computer program which, when executed by a processor, causes the processor to implement the method in accordance with the first aspect.

According to the motor control method and apparatus, device, and storage medium provided in the present disclosure, a rotational speed error of a rotor of a motor corresponding to a current moment is acquired as a first rotational speed error; a speed compensation value is acquired for the rotor according to a speed drop graph which is preset, where the speed drop graph represents a graphical representation of speed versus time when a rotational speed of the rotor drops; an electric current compensation value is calculated according to the speed compensation value and a speed-current mapping model which is preset; an electric current reference value corresponding to the current moment is acquired, where the electric current reference value is an electric current value for controlling the rotational speed of the rotor; and the motor is controlled according to the electric current compensation value if the first rotational speed error is greater than a preset error; or the motor is controlled according to the electric current reference value if the first rotational speed error is less than or equal to the preset error. By calculating the speed compensation value according to the speed drop graph and then acquiring the corresponding electric current compensation value according to the speed compensation value to control the motor, the accuracy of speed compensation is improved.

### BRIEF DESCRIPTION OF DRAWINGS

FIG. 1 is an optional flowchart of a motor control method according to an embodiment of the present disclosure;

FIG. 2 is a flowchart of S102 in FIG. 1;

FIG. 3 is a schematic diagram of a speed drop graph according to an embodiment of the present disclosure;

FIG. 4 is a flowchart of a motor control method according to another embodiment of the present disclosure;

FIG. 5 is a schematic enlarged view of a speed drop region according to an embodiment of the present disclosure;

FIG. 6 is a flowchart of a motor control method according to a third embodiment of the present disclosure;

FIG. 7 is a flowchart of S101 in FIG. 1;

FIG. 8 is a schematic structural diagram of a motor control apparatus according to an embodiment of the present disclosure; and

FIG. 9 is a schematic structural diagram of hardware of an electronic device according to an embodiment of the present disclosure.

### DETAILED DESCRIPTION

To make the objectives, technical schemes, and advantages of the present disclosure clearer, the present disclosure is described in further detail in conjunction with accompanying drawings and embodiments. It should be understood that the specific embodiments described herein are merely used for illustrating the present disclosure, and are not intended to limit the present disclosure.

It is to be noted, although functional modules have been divided in the schematic diagrams of apparatuses and logical orders have been shown in the flowcharts, in some cases, the modules may be divided in a different manner, or the steps shown or described may be executed in an order different from the orders as shown in the flowcharts. The terms such as “first”, “second” and the like in the description, the claims, and the accompanying drawings are used to distinguish similar objects, and are not necessarily used to describe a specific sequence or a precedence order.

Unless otherwise defined, meanings of all technical and scientific terms used in the description are the same as those usually understood by those having ordinary skills in the art to which the present disclosure belongs. Terms used in the description are merely intended to describe objectives of the embodiments of the present disclosure, but are not intended to limit the present disclosure.

A motor may experience a certain degree of speed drop during operation due to a sudden change of the external environment or a sudden external disturbance, and such a drop sometimes leads to the instability and stall of the motor. Therefore, when a speed drop occurs, it is necessary to quickly compensate for the speed drop of the motor. In the related art, compensation for the speed drop of the motor using a load torque observer is an indirect compensation scheme based on a physical model. The physical model is usually a simplified model, and some parameters in the simplified model are uncertain, resulting in insufficient accuracy of the simplified model and unsatisfactory compensation effect.

In view of the above, embodiments of the present disclosure provide a motor control method and apparatus, a device, and a storage medium, and are aimed at analyzing a speed drop pattern in a motor speed control curve after a load is suddenly applied, and designing a graphic representation of speed versus time when a rotor of a motor experiences a speed drop, to obtain a speed drop graph. A control amount reverse to the speed drop is acquired from the speed drop graph to obtain a speed compensation value for the rotor, and then an electric current compensation value corresponding to the speed compensation value is acquired. When a rotational speed error of the rotor corresponding to a current moment is greater than a preset error, the motor is controlled according to the electric current compensation value; otherwise, no compensation is required, and the motor is directly controlled according to an electric current reference value. By calculating the speed compensation value according to the speed drop graph and then acquiring the corresponding electric current compensation value according to the speed compensation value to control the motor, the accuracy of speed compensation is improved.

The motor control method and apparatus, device, and storage medium provided in the embodiments of the present disclosure will be described in detail through the following embodiments. The motor control method in the embodiments of the present disclosure is described first.

In the embodiments of the present disclosure, related data may be acquired and processed based on an artificial intelligence (AI) technology. AI is a theory, method, technology, and application system that uses a digital computer or a machine controlled by the digital computer to simulate, extend, and expand human intelligence, perceive an environment, acquire knowledge, and use the knowledge to obtain an optimal result.

Basic technologies of AI generally include technologies such as sensors, dedicated AI chips, cloud computing, distributed storage, big data processing technology, operating/interaction system, mechatronics, etc. Software technologies of AI mainly include computer vision technology, robotics technology, biometric technology, speech processing technology, natural language processing technology, machine learning/deep learning, etc.

The motor control method provided in the embodiments of the present disclosure may be applied to a terminal device or a server, or may be software running in a terminal device or a server. In some embodiments, the terminal device may be a smartphone, a tablet computer, a notebook computer, a desktop computer, or the like. The server may be configured as an independent physical server, or may be configured as a server cluster or distributed system including a plurality of physical servers, or may be configured as a cloud server providing basic cloud computing services, such as a cloud service, a cloud database, cloud computing, a cloud function, cloud storage, a network service, cloud communication, a middleware service, a domain name service, a security service, a Content Delivery Network (CDN), big data, and an artificial intelligence platform. The software may be an application for implementing the motor control method, etc. However, the present disclosure is not limited to the above forms.

The present disclosure may be used in a wide variety of general purpose or special purpose computer system environments or configurations, for example, personal computers (PCs), server computers, handheld or portable devices, tablet-type devices, multiprocessor systems, microprocessor-based systems, set-top boxes, programmable consumer electronic devices, network PCs, midrange computers, mainframe computers, distributed computing environments including any of the above systems or devices, etc. The present disclosure may be described in the general context of computer-executable instructions executed by a computer, for example, program modules. Generally, the program modules include routines, programs, objects, components, data structures, and the like for performing specific tasks or implementing specific abstract data types. The present disclosure may also be practiced in distributed computing environments in which tasks are performed by remote processing devices connected through a communication network. In a distributed computing environment, program modules may be located in local and remote computer storage media, including storage devices.

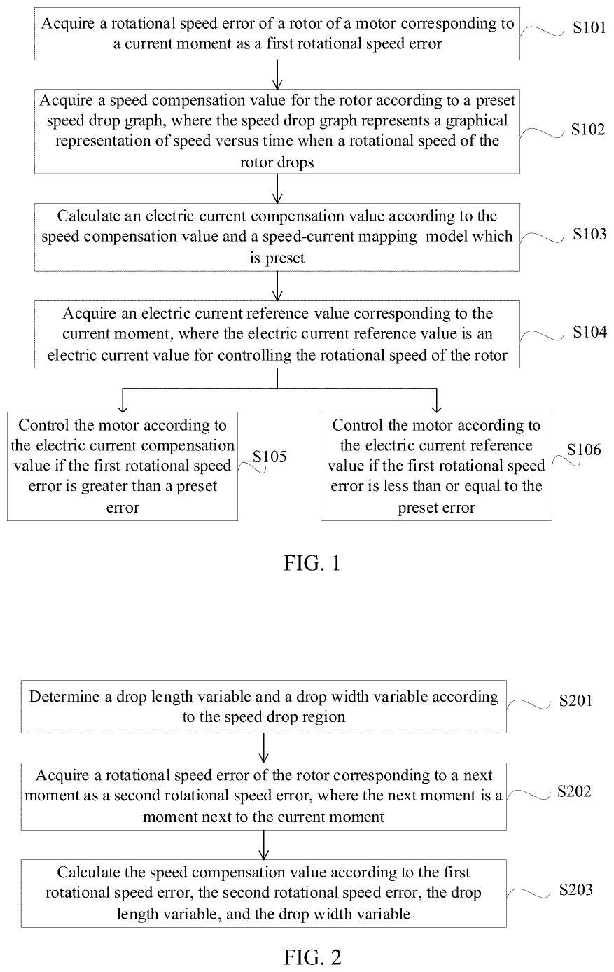

FIG. 1 is an optional flowchart of a motor control method according to an embodiment of the present disclosure. The method in FIG. 1 may include, but not limited to, the following steps S101 to S106.

At S101, a rotational speed error of a rotor of a motor corresponding to a current moment is acquired as a first rotational speed error.

At S102, a speed compensation value is acquired for the rotor according to a speed drop graph which is preset, where the speed drop graph represents a graphical representation of speed versus time when a rotational speed of the rotor drops.

At S103, an electric current compensation value is calculated according to the speed compensation value and a speed-current mapping model which is preset.

At S104, an electric current reference value corresponding to the current moment is acquired, where the electric current reference value is an electric current value for controlling the rotational speed of the rotor.

At S105, the motor is controlled according to the electric current compensation value if the first rotational speed error is greater than a preset error.

At S106, the motor is controlled according to the electric current reference value if the first rotational speed error is less than or equal to the preset error.

In some embodiments, in S101, the electric current reference value is an electric current value for controlling the rotational speed of the rotor, and the rotational speed of the rotor corresponding to the electric current reference value is a speed reference value. When an actual rotational speed of the rotor is not equal to the speed reference value, it indicates that there is an error in the rotational speed of the rotor. When the motor experiences a speed drop, the corresponding rotational speed error is greater than the preset error, and speed compensation is required. Therefore, the rotational speed error of the rotor corresponding to the current moment needs to be acquired to obtain the first rotational speed error, so as to determine whether speed compensation is required based on the first rotational speed error.

Referring to FIG. 2, in some embodiments, the speed drop graph includes a speed drop region, and S102 may include, but not limited to, the following steps S201 to S203.

At S201, a drop length variable and a drop width variable are determined according to the speed drop region.

At S202, a rotational speed error of the rotor corresponding to a next moment is acquired as a second rotational speed error, where the next moment is a moment next to the current moment.

At S203, the speed compensation value is calculated according to the first rotational speed error, the second rotational speed error, the drop length variable, and the drop width variable.

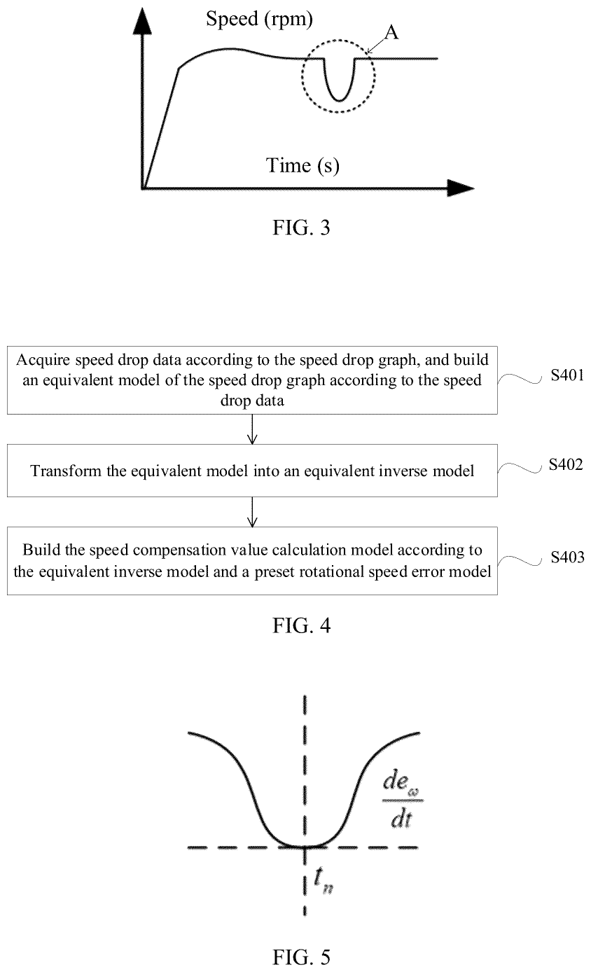

FIG. 3 is a schematic diagram of a speed drop graph according to an embodiment of the present disclosure. In some embodiments, in S201, as shown in FIG. 3, A represents the speed drop region, the drop length variable is the length of the speed drop region, and the drop width variable is the width of the speed drop region. The speed drop region may be determined in advance by manual parameter adjustment in an experiment.

In some embodiments, in S202 to S203, a rotational speed error of the rotor corresponding to a next moment is acquired as a second rotational speed error, where the next moment is a moment next to the current moment. The speed compensation value is calculated according to the first rotational speed error, the second rotational speed error, the drop length variable, and the drop width variable. For example, the first rotational speed error, the second rotational speed error, the drop length variable, and the drop width variable are inputted into a speed compensation value calculation model which is preset to obtain the speed compensation value. The speed compensation value calculation model is expressed by the following formulas (1) to (2):

$$\tilde{ω} = {σ}_{f}^{2} exp ( - {‖ {e}_{{ω}_{k + 1}} - {e}_{{ω}_{k}} ‖}_{2}^{2} / {\tilde{l}}^{2} ) , \qquad ( 1 )$$

$${\tilde{l}}^{2} = {‖ {( \frac{d {e}_{ω}}{d f} )}^{- 1} ‖}_{2}^{- 2} 2 {l}^{2} , \qquad ( 2 )$$

where \tilde{ω} represents the speed compensation value, σ_{f} represents the drop length variable, σ_{f}ϵ [symbol] , l represents the drop width variable, lϵ [symbol] , e_{ω}_{ₖ} represents the first rotational speed error, e_{ω}_{ₖ₊₁} represents the second rotational speed error, \tilde{l} represents an intermediate parameter and has no specific meaning, and e_{ω} represents a rotational speed error of the rotor.

Through the steps S201 to S203 illustrated in the embodiments of the present disclosure, the speed compensation value is calculated according to the first rotational speed error, the second rotational speed error, the drop length variable, and the drop width variable. The speed compensation value is a control amount in a reverse direction of the speed drop region, and therefore can compensate for the speed drop.

In some embodiments, in S103, the speed reference value is a theoretical rotational speed of the rotor when the motor is controlled according to the electric current reference value, and directly using the speed compensation value for compensation to reach the speed reference value causes a compensation delay. Therefore, it is necessary to introduce a predictive element. Compared with the speed loop, the current loop has a prediction attribute. Therefore, the electric current compensation value corresponding to the speed compensation value needs to be calculated according to the speed compensation value and the speed-current mapping model which is preset.

In some embodiments, in S104 to S106, the electric current reference value corresponding to the current moment is acquired; when speed compensation is required, i.e., when the first rotational speed error is greater than the preset error, the motor is controlled according to the electric current compensation value; and when no speed compensation is required, i.e., when the first rotational speed error is less than or equal to the preset error, the motor is controlled according to the electric current reference value. A switching control strategy is expressed by the following formulas (3) to (4):

$${\tilde{I}}_{{q}_{ref , k}} = \frac{\partial {I}_{{q}_{k}}}{\partial {ω}_{k + 1}} \tilde{ω} + {I}_{{q}_{ref , k}} , {e}_{{ω}_{k}} > {e}_{thres} , \qquad ( 3 )$$

$${\tilde{I}}_{{q}_{ref , k}} = {I}_{{q}_{ref , k}} , {e}_{{ω}_{k}} \leq {e}_{thres} , \qquad ( 4 )$$

where Ĩ_{q}_{_{ref,k}} represents the electric current compensation value corresponding to the current moment k, I_{q}_{ₖ} represents the q-axis current corresponding to the current moment k, ωₖ₊₁ represents the second actual rotational speed of the rotor corresponding to the next moment k+1, \tilde{ω} represents the speed compensation value, I_{q}_{_{ref,k}} represents the electric current reference value corresponding to the current moment k, e_{ω}_{ₖ} represents the first rotational speed error of the rotor corresponding to the current moment k, and eₜₕᵣₑₛ represents the preset error. When e_{ω}_{ₖ}>eₜₕᵣₑₛ, the motor is controlled according to the formula (3). When e_{ω}_{ₖ}≤eₜₕᵣₑₛ, the motor is controlled according to the formula (4).

Through the steps S101 to S106 illustrated in the embodiments of the present disclosure, a rotational speed error of a rotor of a motor corresponding to a current moment is acquired as a first rotational speed error; a speed compensation value is acquired for the rotor according to a speed drop graph which is preset, where the speed drop graph represents a graphical representation of speed versus time when the rotational speed of the rotor drops; an electric current compensation value is calculated according to the speed compensation value and a speed-current mapping model which is preset; an electric current reference value corresponding to the current moment is acquired, where the electric current reference value is an electric current value for controlling the rotational speed of the rotor; and the motor is controlled according to the electric current compensation value if the first rotational speed error is greater than a preset error; or the motor is controlled according to the electric current reference value if the first rotational speed error is less than or equal to the preset error. By calculating the speed compensation value according to the speed drop graph and then acquiring the corresponding electric current compensation value according to the speed compensation value to control the motor, the accuracy of speed compensation is improved.

Referring to FIG. 4, in some embodiments, before inputting the first rotational speed error, the second rotational speed error, the drop length variable, and the drop width variable into a speed compensation value calculation model which is preset to obtain the speed compensation value, the motor control method further includes: building the speed compensation value calculation model, including the following steps S401 to S403.

At S401, speed drop data is acquired according to the speed drop graph, and an equivalent model of the speed drop graph is built according to the speed drop data.

At S402, the equivalent model is transformed into an equivalent inverse model.

At S403, the speed compensation value calculation model is built according to the equivalent inverse model and a preset rotational speed error model.

In some embodiments, in S401, the speed drop data includes a drop length variable and a drop width variable. FIG. 5 is a schematic enlarged view of a speed drop region according to an embodiment of the present disclosure. As shown in FIG. 5,

$$\frac{{de}_{ω}}{dt} = 0$$

is a time point at which the speed drop reaches a maximum value, which is defined as tₙ. tₙ may be considered as a midpoint value of a negative square exponential equation. Therefore, the equivalent model of the speed drop graph is expressed by formula (5) below:

$${ω}_{drop} = - {σ}_{f}^{2} exp ( - {‖ t - {t}_{n} ‖}_{2}^{2} / 2 {l}^{2} ) , \qquad ( 5 )$$

where ω_{drop} represents the rotational speed of the rotor, σ_{f} represents the drop length variable, l represents the drop width variable, σ_{f}, lϵ [symbol] , t represents a time variable, tₙ represents the time point at which the speed drops to the minimum, and t, tₙϵ [symbol] . In the formula (5), different parameter combinations may form different forms of speed decline.

In some embodiments, in S402, to compensate for the speed drop, an inverse formula of the formula (5) is designed, and the equivalent model is transformed into an equivalent inverse model, which is expressed by formula (6) below.

$$\tilde{ω} = - {ω}_{drop} = {σ}_{f}^{2} exp ( - {‖ t - {t}_{n} ‖}_{2}^{2} / 2 {l}^{2} ) , \qquad ( 6 )$$

where \tilde{ω} represents the speed compensation value, σ_{f} represents the drop length variable, l represents the drop width variable, t represents a time variable, and tₙ represents the time point at which the speed drops to the minimum.

In some embodiments, in S403, because the time variable t cannot be used as an input to a compensator, but the time tₙ at which the speed drops to the minimum is a useful variable, it is considered to regard each step as tₙ. Therefore, from the perspective of a one-dimensional case, the speed error model is expressed by formula (7) below:

$${e}_{{ω}_{k + 1}} - {e}_{{ω}_{k}} = Δ {e}_{ω} = \frac{{de}_{ω}}{dt} Δ t , \qquad ( 7 )$$

where e_{ω}_{ₖ} represents the first rotational speed error of the rotor corresponding to the current moment k, e_{ω}_{ₖ₊₁} represents the second rotational speed error of the rotor corresponding to the next moment, e_{w}_{ₖ}, e_{ω}_{ₖ₊₁}ϵ [symbol] , Δ represents a discrete differential sign, e_{ω} represents the rotational speed error of the rotor, and

$$\frac{d}{dt}$$

represents continuous differentiation. tₖ represents the current moment, tₖ₊₁ represents the next moment, and Δt=tₖ−tₖ₊₁. Because tₙ is considered to be equal to tₖ₊₁, and t is considered to be equal to tₖ, Δt=t−tₙ. Therefore, the following formula (8) is obtained:

$${‖ t - {t}_{n} ‖}_{2}^{2} = {‖ {( \frac{{de}_{ω}}{dt} )}^{- 1} ( {e}_{{ω}_{k + 1}} - {e}_{{ω}_{k}} ) ‖}_{2}^{2} , \qquad ( 8 ) .$$

The formula (8) is substituted into the formula (6) to obtain the following formula (9):

$$\tilde{ω} = {σ}_{f}^{2} exp ( - {‖ {( \frac{{de}_{ω}}{dt} )}^{- 1} ( {e}_{{ω}_{k + 1}} - {e}_{{ω}_{k}} ) ‖}_{2}^{2} / 2 {l}^{2} ) , \qquad ( 9 ) .$$

The following formula (10) is obtained from the formula (9):

$$\tilde{ω} = {σ}_{f}^{2} exp ( - {‖ ( {e}_{{ω}_{k + 1}} - {e}_{{ω}_{k}} ) ‖}_{2}^{2} {‖ {( \frac{{de}_{ω}}{dt} )}^{- 1} ‖}_{2}^{2} / 2 {l}^{2} ) , \qquad ( 10 ) .$$

By moving

$${‖ {( \frac{{de}_{ω}}{dt} )}^{- 1} ‖}_{2}^{2}$$

in the formula (10) to the denominator, the following formula (11) can be obtained:

$$\tilde{ω} = {σ}_{f}^{2} exp ( - {‖ ( {e}_{{ω}_{k + 1}} - {e}_{{ω}_{k}} ) ‖}_{2}^{2} / ( {‖ {( \frac{{de}_{ω}}{dt} )}^{- 1} ‖}_{2}^{- 2} 2 {l}^{2} ) ) , \qquad ( 11 ) .$$

When

$${\tilde{l}}^{2} = {‖ {( \frac{{de}_{ω}}{dt} )}^{- 1} ‖}_{2}^{- 2} 2 {l}^{2} ,$$

the formula (11) can be transformed into formula (12) below:

$$\tilde{ω} = {σ}_{f}^{2} exp ( - {‖ {e}_{{ω}_{k + 1}} - {e}_{{ω}_{k}} ‖}_{2}^{2} / {\tilde{l}}^{2} ) , \qquad ( 12 ) .$$

The formula (12) is the speed compensation value calculation model built according to the equivalent inverse model and the preset rotational speed error model.

Through the steps S401 to S403 illustrated in the embodiments of the present disclosure, the speed compensation value calculation model is built, and the speed compensation value is calculated based on the speed compensation value calculation model.

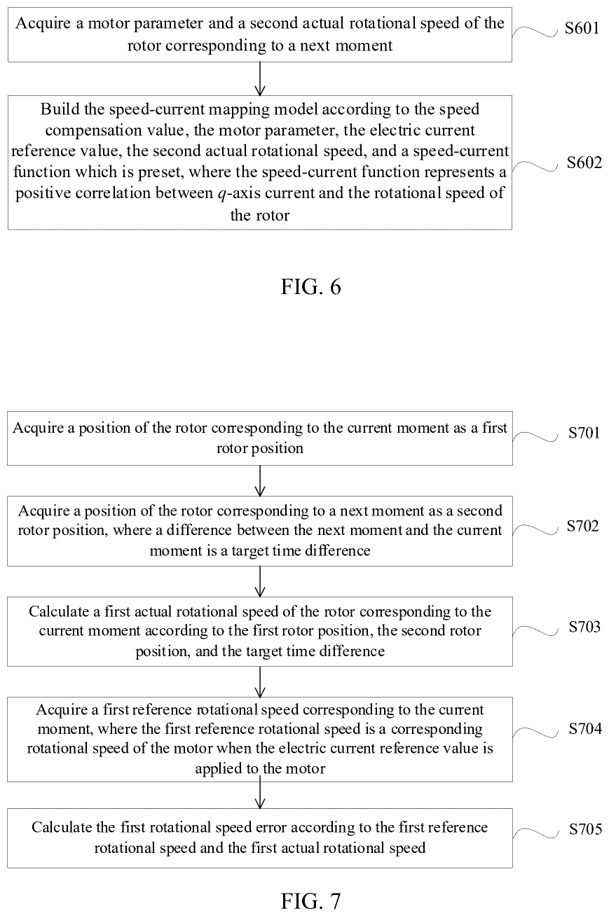

Referring to FIG. 6, in some embodiments, before S103, the motor control method further includes: building the speed-current mapping model, which may include, but not limited to, the following steps S601 to S602.

At S601, a motor parameter and a second actual rotational speed of the rotor corresponding to a next moment are acquired.

At S602, the speed-current mapping model is built according to the speed compensation value, the motor parameter, the electric current reference value, the second actual rotational speed, and a speed-current function which is preset, where the speed-current function represents a positive correlation between a q-axis current and the rotational speed of the rotor.

In some embodiments, in S601, the motor parameter includes a number of pole pairs, a flux linkage, an inertia, a q-axis current corresponding to the current moment, a d-axis current corresponding to a previous moment, a d-axis inductance, and a q-axis inductance. To incorporate the formula (12) into the current, a partial derivative is defined as

$$\frac{\partial {I}_{{q}_{k}}}{\partial {ω}_{k + 1}} , and \frac{\partial {I}_{{q}_{k}}}{\partial {ω}_{k + 1}}$$

can be calculated according to motor parameters.

In some embodiments, in S602, the speed-current function represents a positive correlation between a q-axis current and the rotational speed of the rotor. Therefore, the speed-current mapping model can be built according to the speed compensation value, the motor parameter, the electric current reference value, the second actual rotational speed, and a speed-current function which is preset.

For example, the speed-current mapping model is expressed by the following formulas (13) to (14):

$$\frac{\partial {I}_{{q}_{k}}}{\partial {ω}_{k + 1}} = {( \frac{\partial {ω}_{k + 1}}{\partial \vert {I}_{{q}_{k}} \vert} )}^{- 1} = {( ( \frac{3 {p}_{n} {ψ}_{f}}{2 {J}_{m}} + \frac{3 {p}_{n} ( {L}_{d} - {L}_{q} ) {I}_{d , k - 1}}{2 {J}_{m}} ) {T}_{s} )}^{- 1} , \qquad ( 13 )$$

$${\tilde{I}}_{{q}_{ref , k}} = \frac{\partial {I}_{{q}_{k}}}{\partial {ω}_{k + 1}} \tilde{ω} + {I}_{{q}_{ref , k}} , \qquad ( 14 )$$

where I_{q}_{ₖ} represents the q-axis current corresponding to the current moment, ωₖ₊₁ represents the second actual rotational speed, pₙ represents the number of pole pairs, ψ_{f} represents the flux linkage, ψ_{f}ϵ [symbol] , Jₘ represents the inertia, Jₘϵ [symbol] , L_{d} represents the d-axis inductance, L_{q} represents the q-axis inductance, L_{d}, L_{q}ϵ [symbol] , I_{d,k-1} represents the d-axis current corresponding to the previous moment, Tₛ represents a time difference between the next moment and the current moment, Ĩ_{q}_{_{ref,k}} represents the electric current compensation value, \tilde{ω} represents the speed compensation value, and I_{q}_{_{ref,k}} represents the electric current reference value.

Through the steps S601 to S602 illustrated in the embodiments of the present disclosure, the speed-current mapping model is built, and the electric current compensation value is obtained based on the speed-current mapping model and the speed compensation value.

Referring to FIG. 7, in some embodiments, S101 may include, but not limited to, the following steps S701 to S705.

At S701, a position of the rotor corresponding to the current moment is acquired as a first rotor position.

At S702, a position of the rotor corresponding to a next moment is acquired as a second rotor position, where a difference between the next moment and the current moment is a target time difference.

At S703, a first actual rotational speed of the rotor corresponding to the current moment is calculated according to the first rotor position, the second rotor position, and the target time difference.

At S704, a first reference rotational speed corresponding to the current moment is acquired, where the first reference rotational speed is a corresponding rotational speed of the motor when the electric current reference value is applied to the motor.

At S705, the first rotational speed error is calculated according to the first reference rotational speed and the first actual rotational speed.

In some embodiments, in S701 to S702, the actual rotational speed of the rotor may be calculated according to positions of the rotor that are acquired by a sensor at different moments. Therefore, the position of the rotor corresponding to the current moment is acquired as the first rotor position θₖ, and the position of the rotor corresponding to the next moment is acquired as the second rotor position θₖ₊₁.

In some embodiments, in S703, a difference between the next moment and the current moment is a target time difference Tₛ, and the rotational speed is calculated according to the first rotor position, the second rotor position, and the target time difference, as expressed by the following formula (15):

$${ω}_{k} = ( {θ}_{k + 1} - {θ}_{k} ) / {T}_{s} , \qquad ( 15 )$$

where ωₖ represents the first actual rotational speed, θₖ represents the first rotor position, θₖ₊₁ represents the second rotor position, and Tₛ represents the target time difference.

In some embodiments, in S704, the first reference rotational speed is a rotational speed of the rotor corresponding to the current moment when the motor is controlled according to the electric current reference value, i.e., a corresponding rotational speed of the motor when the electric current reference value is applied to the motor. Theoretically, the rotational speed of the rotor corresponding to the current moment should be the first reference rotational speed, and the actual rotational speed of the rotor corresponding to the current moment should be the first actual rotational speed. When a speed drop occurs, the first reference rotational speed and the first actual rotational speed are not equal.

In some embodiments, in S705, the first rotational speed error is a difference between the first reference rotational speed and the first actual rotational speed. The second rotational speed error may also be calculated by the above method, and the specific calculation process will not be repeated herein.

Through the steps S701 to S705 illustrated in the embodiments of the present disclosure, the actual rotational speed of the rotor is obtained according to the positions of the rotor corresponding to different moments, and the rotational speed error is obtained based on the actual rotational speed of the rotor.

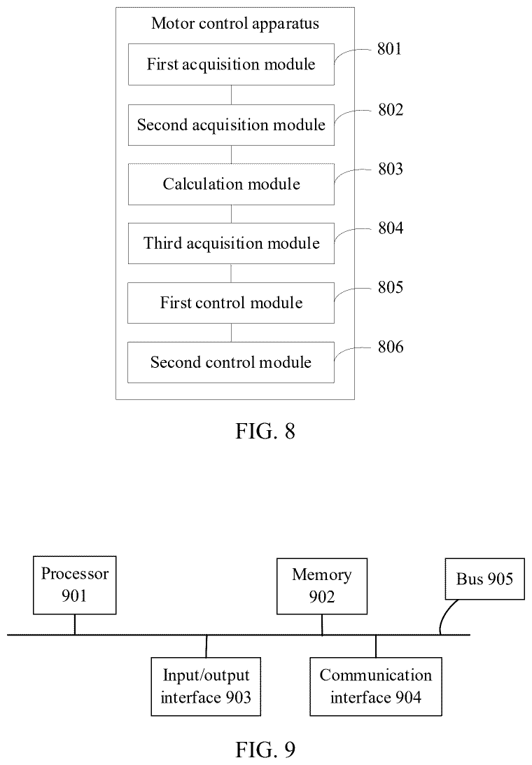

Referring to FIG. 8, an embodiment of the present disclosure further provides a motor control apparatus capable of implementing the above motor control method. The apparatus includes:
a first acquisition module 801, configured for acquiring a rotational speed error of a rotor of a motor corresponding to a current moment as a first rotational speed error;
a second acquisition module 802, configured for acquiring a speed compensation value for the rotor according to a speed drop graph which is preset, where the speed drop graph represents a graphical representation of speed versus time when the rotational speed of the rotor drops;
a calculation module 803, configured for calculating an electric current compensation value according to the speed compensation value and a speed-current mapping model which is preset;
a third acquisition module 804, configured for acquiring an electric current reference value corresponding to the current moment, where the electric current reference value is an electric current value for controlling the rotational speed of the rotor;
a first control module 805, configured for controlling the motor according to the electric current compensation value if the first rotational speed error is greater than a preset error; and
a second control module 806, configured for controlling the motor according to the electric current reference value if the first rotational speed error is less than or equal to the preset error.

Specific embodiments of the motor control apparatus are basically the same as the specific embodiments of the motor control method, so the details will not be repeated herein.

An embodiment of the present disclosure provides an electronic device, including a memory and a processor. The memory is configured for storing a computer program. The computer program, when executed by the processor, causes the processor to implement the motor control method described above. The electronic device may include any smart terminal device such as a tablet computer or an in-vehicle computer.

FIG. 9 shows a hardware structure of an electronic device according to another embodiment. Referring to FIG. 9, the electronic device includes a processor 901, a memory 902, an input/output interface 903, a communication interface 904, and a bus 905.

The processor 901 may be implemented by a general-purpose Central Processing Unit (CPU), a microprocessor, an Application Specific Integrated Circuit (ASIC), or one or more integrated circuits, and is configured for executing a related program to implement the technical schemes provided by the embodiments of the present disclosure.

The memory 902 may be implemented in the form of a Read Only Memory (ROM), a static storage device, a dynamic storage device, a Random Access Memory (RAM), etc. The memory 902 may store an operating system and other application programs. When the technical schemes provided by the embodiments of the present disclosure are implemented by software or firmware, related program code is stored in the memory 902 which, when called by the processor 901, causes the processor 901 to implement the motor control method according to the embodiments of the present disclosure.

The input/output interface 903 is configured for enabling input and output of information.

The communication interface 904 is configured for realizing communication interaction between the electronic device and other devices, either through wired communication (e.g., USB, network cable, etc.) or through wireless communication (e.g., mobile network, Wi-Fi, Bluetooth, etc.).

The bus 905 is configured for transmitting information between components of the electronic device (such as the processor 901, the memory 902, the input/output interface 903, and the communication interface 904).

The processor 901, the memory 902, the input/output interface 903, and the communication interface 904 are in communication connection with each other inside the electronic device through the bus 905.

An embodiment of the present disclosure provides a computer-readable storage medium, storing a computer program which, when executed by a processor, causes the processor to implement the motor control method described above.

The memory, as a non-transitory computer-readable storage medium, may be configured for storing a non-transitory software program and a non-transitory computer-executable program. In addition, the memory may include a high-speed random access memory, and may also include a non-transitory memory, e.g., at least one magnetic disk storage device, flash memory device, or other non-transitory solid-state storage device. In some implementations, the memory may include memories located remotely from the processor, and the remote memories may be connected to the processor via a network. Examples of the network include, but not limited to, the Internet, an intranet, a local area network, a mobile communication network, and combinations thereof.

The contents described in the embodiments of the present disclosure are for the purpose of illustrating the technical schemes of the embodiments of the present disclosure more clearly, and do not constitute a limitation to the technical schemes provided in the embodiments of the present disclosure. Those having ordinary skills in the art may know that with the evolution of technologies and the emergence of new application scenarios, the technical schemes provided in the embodiments of the present disclosure are also applicable to similar technical problems.

Those having ordinary skills in the art may understand that the technical scheme shown in the drawings does not constitute a limitation to the embodiments of the present disclosure, and more or fewer steps than those shown in the figure may be included, or some steps may be combined, or different steps may be used.

The apparatus embodiments described above are merely examples. The units described as separate components may or may not be physically separated, i.e., they may be located in one place or may be distributed over a plurality of network units. Some or all of the modules may be selected according to actual needs to achieve the objects of the scheme of this embodiment.

Those having ordinary skills in the art can understand that all or some of the steps in the methods disclosed above and the functional modules/units in the system and the apparatus can be implemented as software, firmware, hardware, and appropriate combinations thereof.

In the specification and accompanying drawings of the present disclosure, the terms “first”, “second”, “third”, “fourth”, and so on (if any) are intended to distinguish between similar objects, but do not necessarily indicate a specific order or sequence. It is to be understood that the data termed in such a way are interchangeable in appropriate circumstances, such that the embodiments of the present disclosure described herein can be implemented in orders other than the order illustrated or described herein. Moreover, the terms “include,” “comprise,” and any other variants thereof mean are intended to cover a non-exclusive inclusion. For example, a process, method, system, product, or device that includes a list of operations or units is not necessarily limited to those expressly listed steps or units, but may include other steps or units not expressly listed or inherent to such a process, method, product, or device.

It is to be understood that in the present disclosure, “at least one” means one or more and “a plurality of” means two or more. The term “and/or” is used for describing an association between associated objects and representing that three associations may exist. For example, “A and/or B” may indicate that only A exists, only B exists, and both A and B exist, where A and B may be singular or plural. The character “/” generally indicates an “or” relation between the associated objects. “At least one of” and similar expressions refer to any combination of items listed, including one item or any combination of a plurality of items. For example, at least one of a, b, or c may represent a, b, c, “a and b”, “a and c”, “b and c”, or “a, b, and c”, where a, b, and c may be singular or plural.

In the several embodiments provided in the present disclosure, it is to be understood that the disclosed apparatus and method may be implemented in other manners. For example, the described apparatus embodiments are only exemplary. For example, the division of the units is merely a logical function division and other division manners may be used in practical implementations. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separate. Parts displayed as units may or may not be physical units, and they may be located in one position, or may be distributed over a plurality of network units. Some or all of the units may be selected according to actual needs to achieve the objects of the scheme of this embodiment.

In addition, functional units in the embodiments of the present disclosure may be integrated into one processing unit, or each of the units may exist alone physically, or two or more units may be integrated into one unit. The integrated unit may be implemented in the form of hardware, or may be implemented in the form of a software functional unit.

The integrated unit may be stored in a computer-readable storage medium if implemented in the form of a software functional unit and sold or used as an independent product. Based on such an understanding, the technical schemes of the present disclosure essentially, or the part contributing to the related art, or all or some of the technical schemes may be implemented in the form of a software product. The software product is stored in a storage medium, and includes several instructions for instructing a computer device (which may be a personal computer, a server, a network device, or the like) to execute all or some of the steps of the methods described in the embodiments of the present disclosure. The foregoing storage medium includes: any medium that can store program code, such as a USB flash drive, a removable hard disk, a ROM, a RAM, a magnetic disk, or an optical disk.

Although some embodiments of the present disclosure are described above with reference to the accompanying drawings, these embodiments are not intended to limit the protection scope of the embodiments of the present disclosure. Any modifications, equivalent replacements and improvements made by those having ordinary skills in the art without departing from the scope and essence of the embodiments of the present disclosure shall fall within the protection scope of the embodiments of the present disclosure.

What is claimed is:

1. A motor control method, comprising:
acquiring a rotational speed error of a rotor of a motor corresponding to a current moment as a first rotational speed error;
acquiring a speed compensation value for the rotor according to a speed drop graph which is preset, wherein the speed drop graph represents a graphical representation of speed versus time when a rotational speed of the rotor drops;
calculating an electric current compensation value according to the speed compensation value and a speed-current mapping model which is preset;
acquiring an electric current reference value corresponding to the current moment, wherein the electric current reference value is an electric current value for controlling the rotational speed of the rotor;
controlling the motor according to the electric current compensation value in response to the first rotational speed error being greater than a preset error; and
controlling the motor according to the electric current reference value in response to the first rotational speed error being less than or equal to the preset error.

2. The method of claim 1, wherein the speed drop graph comprises a speed drop region, and acquiring a speed compensation value for the rotor according to a speed drop graph which is preset comprises:
determining a drop length variable and a drop width variable according to the speed drop region;
acquiring a rotational speed error of the rotor corresponding to a next moment as a second rotational speed error, wherein the next moment is a moment next to the current moment; and
calculating the speed compensation value according to the first rotational speed error, the second rotational speed error, the drop length variable, and the drop width variable.

3. The method of claim 2, wherein calculating the speed compensation value according to the first rotational speed error, the second rotational speed error, the drop length variable, and the drop width variable comprises:
inputting the first rotational speed error, the second rotational speed error, the drop length variable, and the drop width variable into a speed compensation value calculation model which is preset to obtain the speed compensation value,
wherein the speed compensation value calculation model is:
$$\tilde{ω} = {σ}_{f}^{2} exp ( - {‖ {e}_{{ω}_{k + 1}} - {e}_{{ω}_{k}} ‖}_{2}^{2} / {\tilde{l}}^{2} ) ;$$
$${\tilde{l}}^{2} = {‖ {( \frac{{de}_{ω}}{dt} )}^{- 1} ‖}_{2}^{- 2} 2 {l}^{2} ;$$
wherein \tilde{ω} represents the speed compensation value, σ_{f} represents the drop length variable, σ_{f}ϵ [symbol] , l represents the drop width variable, lϵ [symbol] , e_{ω}_{ₖ} represents the first rotational speed error, e_{ω}_{ₖ₊₁} represents the second rotational speed error, \tilde{l} represents an intermediate parameter, and e_{ω} represents a rotational speed error of the rotor.

4. The method of claim 3, wherein before inputting the first rotational speed error, the second rotational speed error, the drop length variable, and the drop width variable into a speed compensation value calculation model which is preset to obtain the speed compensation value, the method further comprises:
building the speed compensation value calculation model, comprising:
acquiring speed drop data according to the speed drop graph, and building an equivalent model of the speed drop graph according to the speed drop data;
transforming the equivalent model into an equivalent inverse model; and
building the speed compensation value calculation model according to the equivalent inverse model and a preset rotational speed error model.

5. The method of claim 1, wherein before calculating an electric current compensation value according to the speed compensation value and a speed-current mapping model which is preset, the method further comprises:
building the speed-current mapping model, comprising:
acquiring a motor parameter and a second actual rotational speed of the rotor corresponding to a next moment; and
building the speed-current mapping model according to the speed compensation value, the motor parameter, the electric current reference value, the second actual rotational speed, and a speed-current function which is preset, wherein the speed-current function represents a positive correlation between a q-axis current and the rotational speed of the rotor.

6. The method of claim 5, wherein the motor parameter comprises a number of pole pairs, a flux linkage, an inertia, a q-axis current corresponding to the current moment, a d-axis current corresponding to a previous moment, a d-axis inductance, and a q-axis inductance, and building the speed-current mapping model according to the speed compensation value, the motor parameter, the electric current reference value, the second actual rotational speed, and a speed-current function which is preset comprises:
building the speed-current mapping model according to the speed compensation value, the number of pole pairs, the flux linkage, the inertia, the q-axis current corresponding to the current moment, the d-axis current corresponding to the previous moment, the d-axis inductance, and the q-axis inductance, the electric current reference value, the second actual rotational speed, and a preset speed-current relationship,
wherein the speed-current mapping model is:
$$\frac{\partial {I}_{{q}_{k}}}{\partial {ω}_{k + 1}} = {( \frac{\partial {ω}_{k + 1}}{\partial \vert {I}_{{q}_{k}} \vert} )}^{- 1} = {( ( \frac{3 {p}_{n} {ψ}_{f}}{2 {J}_{m}} + \frac{3 {p}_{n} ( {L}_{d} - {L}_{q} ) {I}_{d , k - 1}}{2 {J}_{m}} ) {T}_{s} )}^{- 1} ;$$
$${\tilde{I}}_{{q}_{ref , k}} = \frac{\partial {I}_{{q}_{k}}}{\partial {ω}_{k + 1}} \tilde{ω} + {I}_{{q}_{ref , k}} ;$$
wherein I_{q}_{ₖ} represents the q-axis current corresponding to the current moment, ωₖ₊₁ represents the second actual rotational speed, pₙ represents the number of pole pairs, ψ_{f} represents the flux linkage, ψ_{f}ϵ [symbol] , Jₘ represents the inertia, Jₘϵ [symbol] , L_{d} represents the d-axis inductance, L_{q} represents the q-axis inductance, L_{d}, L_{q}ϵ [symbol] , I_{d,k-1} represents the d-axis current corresponding to the previous moment, Tₛ represents a time difference between the next moment and the current moment, Ĩ_{q}_{_{ref,k}} represents the electric current compensation value, \tilde{ω} represents the speed compensation value, and I_{q}_{_{ref,k}} represents the electric current reference value.

7. The method of claim 1, wherein acquiring a rotational speed error of a rotor of a motor corresponding to a current moment as a first rotational speed error comprises:
acquiring a position of the rotor corresponding to the current moment as a first rotor position;
acquiring a position of the rotor corresponding to a next moment as a second rotor position, wherein a difference between the next moment and the current moment is a target time difference;
calculating a first actual rotational speed of the rotor corresponding to the current moment according to the first rotor position, the second rotor position, and the target time difference;
acquiring a first reference rotational speed corresponding to the current moment, wherein the first reference rotational speed is a corresponding rotational speed of the motor when the electric current reference value is applied to the motor; and
calculating the first rotational speed error according to the first reference rotational speed and the first actual rotational speed.

8. A motor control apparatus, comprising:
a first acquisition module, configured for acquiring a rotational speed error of a rotor of a motor corresponding to a current moment as a first rotational speed error;
a second acquisition module, configured for acquiring a speed compensation value for the rotor according to a speed drop graph which is preset, wherein the speed drop graph represents a graphical representation of speed versus time when a rotational speed of the rotor drops;
a calculation module, configured for calculating an electric current compensation value according to the speed compensation value and a speed-current mapping model which is preset;
a third acquisition module, configured for acquiring an electric current reference value corresponding to the current moment, wherein the electric current reference value is an electric current value for controlling the rotational speed of the rotor;
a first control module, configured for controlling the motor according to the electric current compensation value in response to the first rotational speed error being greater than a preset error; and
a second control module, configured for controlling the motor according to the electric current reference value in response to the first rotational speed error being less than or equal to the preset error.

9. An electronic device, comprising a memory and a processor, wherein the memory is configured for storing a computer program which, when executed by the processor, causes the processor to perform the motor control method of claim 1.

10. A non-transitory computer-readable storage medium, storing a computer program which, when executed by a processor, causes the processor to perform the motor control method of claim 1.
